(19) United States
(12) Patent Application Publication
(10) Pub. No.: US 2008/0075412 A1
(43) Pub. Date: Mar. 27, 2008

(54) FIBER OPTIC SENSOR WITH PROTECTIVE CLADDING AND FABRICATION METHODS

(75) Inventors: JAMES SCOTT VARTULI, REXFORD, NY (US); KUNG-LI JUSTIN DENG, WATERFORD, NY (US); KEVIN PAUL MCEVOY, BALLSTON SPA, NY (US); KEVIN HENRY JANORA, SCHENECTADY, NY (US); KENNETH SHERWOOD BOUSMAN, ALBANY, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/535,728

(22) Filed: Sep. 27, 2006

(51) Int. Cl. G02B 6/00; G02B 6/02

(52) U.S. Cl. 385/144; 385/123; 385/141; 385/12

(57) ABSTRACT

A sensor includes an optical fiber and coating material surrounding at least a portion of the optical fiber. At least one parameter of the coating material is optimal to minimize normal and shear stresses on the sensor. One material combination includes a sapphire optical fiber and a spinel coating material.

### BACKGROUND

The described structures and methods relate generally to sensors and more particularly to fiber optic sensors.

Thermal exhaust profiling is desirable to provide data for adjusting and maximizing combustion efficiency in power generation systems. Fiber optic grating based sensors have been suggested as one means to obtain measurements in harsh conditions as described in commonly assigned U.S. application Ser. Nos. 11/086,055 and 11/284,5945. It would be desirable to increase the robustness and temperature range of such sensors.

### BRIEF DESCRIPTION

Briefly, in accordance with one embodiment, a sensor comprises an optical fiber comprising sapphire and cladding material surrounding at least a portion of the optical fiber and comprising a spinel.

In accordance with another embodiment, a sensor fabrication method comprises: coating a sapphire fiber of the sensor with a mixture of Al(OR)₃+H₂O and Mg(OR)₂+H₂O, wherein R comprises a hydrocarbon chain, until the coated mixture comprises a gel state; and heating the sapphire fiber and the coated and gelled mixture until the coated and gelled mixture comprises a solid state of magnesium aluminum oxide (MgAl₂O₄).

In accordance with another embodiment, a sensor fabrication method comprises using chemical vapor deposition to apply magnesium aluminum oxide (MgAl₂O₄) around a sapphire fiber.

In accordance with another embodiment, a sensor comprises an optical fiber and coating material surrounding at least a portion of the optical fiber. At least one parameter of the coating material is optimal to minimize normal and shear stresses on the sensor, and the at least one parameter is at least one of melting point, coefficient of thermal expansion, electric modulus, and lattice type.

### DRAWINGS

These and other features, aspects, and advantages of the present invention will become better understood when the following detailed description is read with reference to the accompanying drawings in which like characters represent like parts throughout the drawings, wherein:

FIG. 1 is a side view of a coated fiber.

FIG. 2 is a schematic side view of a fiber being pulled from a container of liquid mixture.

FIG. 3 is a schematic side view of the coated fiber in a heater.

FIG. 4 is a block diagram of a fiber situated in a chemical vapor deposition reactor.

FIG. 5 is a graph illustrating a measurement of refractive index with respect to wavelength.

### DETAILED DESCRIPTION

Diffraction gratings in sapphire (Al₂O₃) fibers enable temperature sensing at higher temperature ranges as compared with traditional optical fiber Bragg grating sensors. A coating material and application process are selected to result in a protective coating that is thermally, chemically, and mechanically robust/stable, and in one embodiment the coating material may also function as a cladding.

Useful optical properties for coating material include: a lower index of refraction than the fiber at the desired operating wavelength (particularly if the coating material will be used as a cladding), and reduced light scattering properties. For example, with respect to the light scattering reduction, cubic crystal lattices (optical isotropic) provide a polycrystalline coating that will not scatter light. Useful thermo-mechanical properties include: high melting point, coefficient of thermal expansion close to that of the fiber, and as low as possible elastic modulus (to reduce impact from thermal strain mismatch). Additional desired properties are: the ability of the coating structure to maintain a good thermal conductivity and fast temperature response, and the ability of the coating to protect the fiber from particulate debris.

One type of material which provides desirable properties as a coating for sapphire was identified to be spinel. Spinel is sometimes defined broadly to include minerals that are oxides of magnesium, iron, zinc, manganese, aluminum, or combinations thereof. The more specific spinel composition of magnesium aluminum oxide (MgAl₂O₄) has been determined to be particularly useful. The optical index of MgAl₂O₄ is 1.72 (as compared with 1.76 or 1.77 for sapphire) and the crystal structure of spinel is cubic (optical isotropic) so a pore-free, phase-pure polycrystalline sample will not scatter light. MgAl₂O₄ has a high melt point of 2135° C. (as compared with a sapphire melt point of 2050° C.). The thermal expansion coefficient of MgAl₂O₄ is close to sapphire at 0.79% isotropic thermal strain value from room temperature to 1000° C. (as compared with, for sapphire, a 0.89% axial thermal strain value and a 0.83% radial thermal strain value). The elastic modulus is relatively low at 270 mega Pascal (MPa) (or 2753 kilogram-forces per square centimeter—KFSC) as compared with 435 MPa (4436 KPSC) in the axial direction and 386 MPa (3936 KPSC) in the radial direction for sapphire.

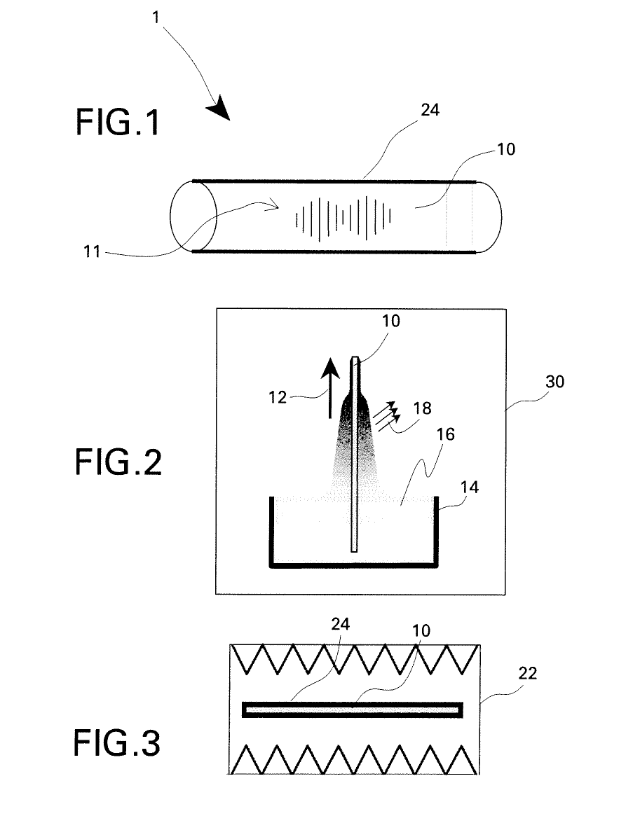

FIG. 1 is a side view of a sensor 1 including an optical fiber 10 and a fiber coating 24. In one embodiment optical fiber 10 comprises sapphire and coating 24 comprises cladding material surrounding at least a portion of the optical fiber and comprising a spinel. In a more specific embodiment, as discussed above, the spinel comprises MgAl₂O₄. Typically the optical fiber includes a diffraction grating 11, and the cladding material surrounds at least the portion of the optical fiber including the diffraction grating.

Cladding material 24 may be applied in any appropriate manner with several examples being illustrated in FIGS. 2-4. FIG. 2 is a schematic side view of a fiber being pulled from a container of liquid mixture, and FIG. 3 is a schematic side view of the coated fiber in a heater.

In one embodiment, a sensor fabrication method comprises: coating a sapphire fiber 10 of the sensor with a mixture of Al(OR)₃+H₂O and Mg(OR)₂+H₂O, wherein R comprises a hydrocarbon chain, until the coated mixture 24 comprises a gel state; and heating the sapphire fiber and the coated and gelled mixture until the coated and gelled mixture comprises a solid state of magnesium aluminum oxide (MgAl₂O₄).

During the liquid phase, the elements of the mixture transition as follows:

Al(OR)₃+H₂O→Al(OR)₂ OH+ROH↑, and

Mg(OR)₂+H₂O→Mg(OR)OH+ROH↑,

wherein R is a hydrocarbon chain with one example comprising isopropane. During the initial gel phase, the transitions progress as follows:

Al(OR)(OH)₂+H₂O→Al(OH)₃+ROH↑, and

Mg(OR)OH+H₂O→Mg(OH)₂+ROH↑.

During the increasingly thicker gel phase, the transitions progress as follows:

Al(OH)₃+ΔT→Al₂O₃+3H₂O↑, and

Mg(OH)₂+ΔT→MgO₂+2H₂O↑.

Finally, to reach the solid phase, the following formula is applicable:

2Al(OH)₃+Al(OH)₂+ΔT→MgAl₂O₄.

In a more specific embodiment, atmospheric humidity is controlled while coating and heating the sapphire fiber. To increase cladding thickness, in some embodiments, the coating process comprises coating multiple layers. Two examples of coating methods include dipping in a mixture 16 (supported by container 14, for example) and pulling through a mixture. Pulling through may be used as a continuous coating technique.

In one experiment, two fibers (each two inches (5.1 cm) long) were positioned in a vertical platinum fixture, cleaned, and coated with a commercial precursor. The commercial precursor comprised spinel purchased from Sigma Aldrich: aluminum magnesium isopropoxide (ten percent by volume) in isopropanol. The fibers were dip coated with MgAl₂O₄ in the direction represented by arrow 12. The coated fibers were then hydrolized in air (to evaporate water and OH as represented by arrows 18) and heated to a temperature of 1000° C. for one hour (in furnace 22 of FIG. 3, for example).

The resulting fiber and coating were then characterized. Initial test results showed good adhesion and uniform radial and axial thicknesses. A beneficial result of using sapphire and MgAl₂O₄ is that sapphire shrinks more than MgAl₂O₄ when the materials cool, thus resulting in a strong ceramic bond. In other words, MgAl₂O₄ is referred to as being “in compression” after cooling back to room temperature, due to its strain in both directions of 0.79% as compared with the strain in sapphire being 0.89% in the axial direction and 0.83% in the radial direction.

In addition to the positive observations, some mud cracking was observed. Mud cracks are cracks that occur in the coating when the cracks are perpendicular to the plane of the coating and usually form a regular spaced pattern. Mud cracks are different from delamination cracks which are along the plane of the coating and cause separation at the coating-fiber interface. It is expected that one useful technique to reduce mud cracking is to increase cross-linking of the gel in a controlled environment. In one example, curing is performed slowly while monitoring humidity. Controlling the humidity can be attempted, for example, by using sheeting or some other divider or box structure 30 (FIG. 2) around the processing assembly.

Another technique to potentially reduce mud cracking is to modify the coating chemistry. For example, a polymer can be added to improve wetting and binding. In one example, glycerol, glycol, ethylene glycol, or a combination thereof is used to improve wetting characteristics. In another example, polyethylene with a molecular weight of 10K (for the average size of the polymer) is used. In another example, precursor density or loading is modified. During initial testing the precursor was at thirty percent (by volume), but it is expected that the percentage can be increased by refluxing to partially hydrolyze the precursor. In another example, adjustments may be made to the solids loading (that is, the amount or concentration of active material).

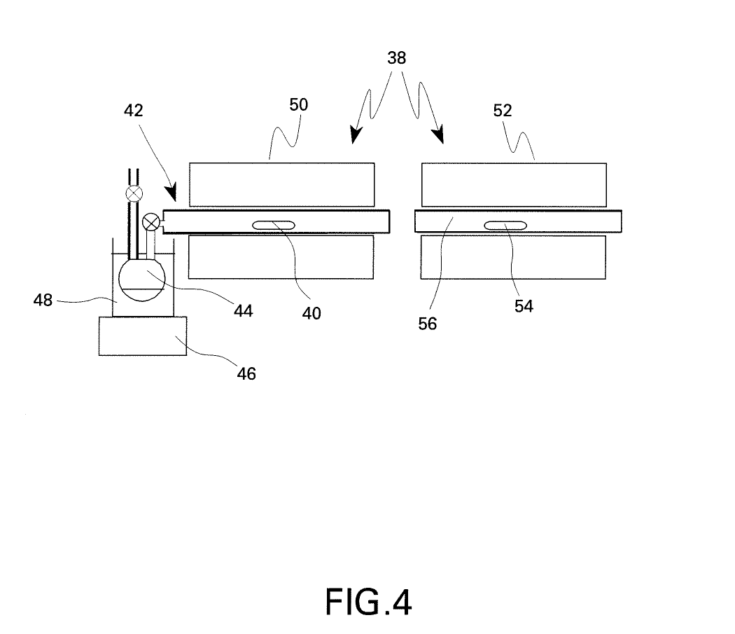

FIG. 4 is a system 38 block diagram of a fiber 40 situated in a chemical vapor deposition (CVD) reactor 42 for use in one embodiment of a sensor fabrication method comprising using CVD to apply MgAl₂O₄ around a sapphire fiber. In a more specific embodiment, using CVD comprises: depositing the MgAl₂O₄ around the sapphire fiber, heating the sapphire fiber and the deposited MgAl₂O₄, and repeating the steps of depositing and heating at least once.

In one experiment, a 1.6 micron cladding of MgAl₂O₄ was deposited by MOCVD (Metalorganic Chemical Vapor Deposition) onto a 0.5 millimeter diameter sapphire fiber which had a long period grating etched into it. Optically polished (on one side) sapphire plates (not shown) were coated simultaneously with the fiber for cladding thickness and refractive index studies. Five CVD runs were conducted with 1400° C. firings between runs to gradually build the MgAl₂O₄ cladding thickness up to the final 1.6 microns. The fiber was situated in a horizontal position within the deposition chamber of reactor furnace 50 (FIG. 4) on one millimeter thick vertical stainless steel (grade 321) supports (not shown) at two locations along its length. The position of the supports was shifted in each of the five CVD coating runs so no sites of the fiber ended up with a significantly thinner cladding. During firing (in chamber 56 of tube furnace 52 of FIG. 4) the horizontal fiber rested on 99.8% alumina supports inside a 99.8% alumina tube to minimize contamination.

The sapphire fibers and plates were cleaned before coating by a five minute ultrasonic treatment in four percent micro low residue detergent and de-ionized water, a de-ionized water rinse, and an isopropanol rinse. The fibers and plates were then fired to 1000° C. in air, with a 15 minute hold at 1000° C. and 100° C./minute ramp rates immediately prior to MOCVD deposition.

A five centimeter diameter MOCVD reactor 42 is illustrated in FIG. 4. Magnesium aluminum isopropoxide was used as the MOCVD precursor. Deposition conditions were 420° C. reactor furnace 50 temperature, 122° C. precursor reservoir 44 temperature (obtained from a hot plate/stirrer 46 and hot oil bath 48), 0.3 torr, no carrier gas, and 1 cc/hr to 3 cc/hr precursor flow. The maximum deposition rate at the furnace center was varied from between 1.5 as-deposited microns/hr to 0.5 as-deposited microns/hr. Changing the deposition rate had no obvious effect on the coating quality. Before shrinkage from firing, 0.25 microns to 0.7 microns of MgAl₂O₄ was deposited in each of the five runs.

After each of the five MOCVD runs, the coated sapphire fibers 54 and plates were fired to 1400° C. in air in a precleaned, 99.8% alumina tube 56 inside a tube furnace 52. The 34 cm long sapphire fiber was longer than the uniform hot zone of the furnace. To compensate, an alumina tray (not shown) holding the fiber was gradually slid through the hot zone to ensure the entire fiber length experienced 1400° C. Time at 1400° C. was typically 30 minutes. Ramp rates up and down were 3° C./min.

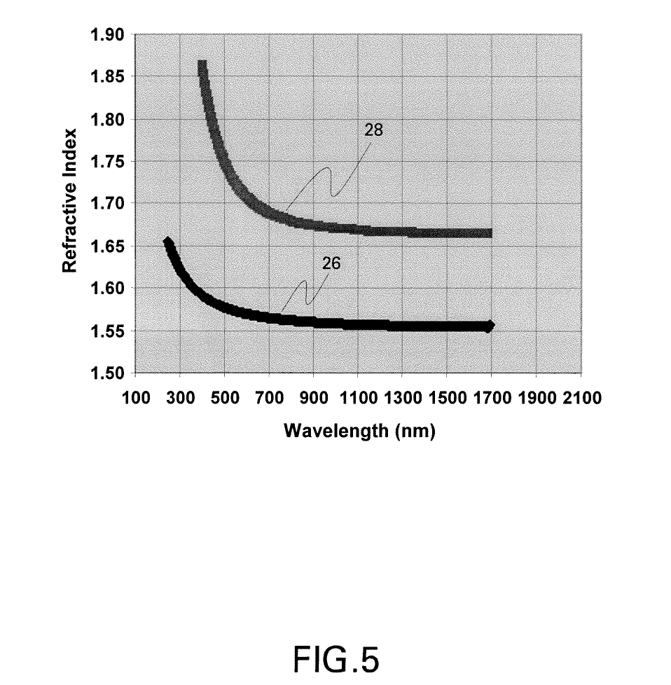

Good specular MgAl₂O₄ coatings with little cloudiness were obtained in each of the five MOCVD coating runs. Profilometry was used to evaluate the MgAl₂O₄ coated sapphire plates, and it was determined that the coating thickness decreases to about 55% of its original thickness after the 1400° C. firing. The cumulative total MgAl₂O₄ thickness of the five MOCVD runs on the sapphire plates was 1.6 microns after the 1400° C. firings. The index of absorption (k) was determined through ellipsometry of both the fired and non-fired MgAl₂O₄ claddings and found to be <0.0005 throughout the 400 nm to 1600 nm wavelength for both. The refractive index of the MgAl₂O₄ coated sapphire plates was measured via ellipsometry. FIG. 5 is a graph illustrating the measurement after one initial run of a CVD coating to a thickness of 0.5 micrometers. One of the coated plates received firing treatment at 1400° C., and the other did not. In FIG. 5, line 26 represents the refractive index of the un-fired plate, and line 28 illustrates the refractive index of the fired plate.

Although the above discussion has been focused upon one material combination that has been found to be particularly beneficial, other embodiments are expected to benefit from the design constraints disclosed herein. In one embodiment, for example, a sensor comprises an optical fiber and coating material surrounding at least a portion of the optical fiber, wherein at least one parameter of the coating material is optimal to minimize normal and shear stresses on the sensor, and wherein the at least one parameter is at least one of melting point, coefficient of thermal expansion, electric modulus, and lattice type.

As one example, this design technique is also believed to be applicable and useful for fibers including high temperature glasses and silica. Additionally, although the example of spinel on sapphire is useful for serving as both a coating and a cladding, in embodiments wherein the coating is for protection and not for cladding, more design flexibility will be available. When the coating material is used for cladding, the coating material typically comprises a lower index of refraction than the index of refraction of the optical fiber.

In one embodiment wherein a selected optimization parameter includes the coefficient of thermal expansion (CTE), the CTE of the coating is selected to be nearly identical to the CTE of fiber. In one embodiment, wherein the coating is designed to be in compression after processing, nearly identical means that the difference between the two CTEs is selected to be less than or equal to 15%. In another embodiment, wherein the coating is designed to be in tension after processing, nearly identical means that the CTE of the coating is at least as high as that of the CTE and not higher by more than five percent. As used herein “in tension” means that the coating is pulled along the axial direction. In compression or tension embodiments, although the CTE of the coating may be somewhat greater than that the fiber, a CTE that is less than that of the fiber may result in cracking from thermal cycle fatigue. The risk of cracking and delamination can be relaxed by using a low elastic modulus coating (more compliant) to reduce interface stress.

Some embodiments use a plurality of parameters. In one example, the combined parameters include melting point, coefficient of thermal expansion, electric modulus, and lattice type. In a more specific example, the lattice type comprises a cubic crystal lattice. As discussed above, in another example, the coating material has a coefficient of thermal expansion greater than or equal to a coefficient of expansion of the optical fiber.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A sensor comprising:
an optical fiber comprising sapphire; and
cladding material surrounding at least a portion of the optical fiber, the cladding material of the sensor comprising a spinel.

2. The sensor of claim 1 wherein the spinel comprises magnesium aluminum oxide (MgAl₂O₄).

3. The sensor of claim 1 wherein the optical fiber includes a diffraction grating, and wherein the cladding material surrounds at least the portion of the optical fiber including the diffraction grating.

4. A sensor fabrication method comprising:
coating a sapphire fiber of the sensor with a mixture of Al(OR)₃+H₂O and Mg(OR)₂+H₂O, wherein R comprises a hydrocarbon chain, until the coated mixture comprises a gel state;
heating the sapphire fiber and the coated and gelled mixture until the coated and gelled mixture comprises a solid state of magnesium aluminum oxide (MgAl₂O₄).

5. The method of claim 4 further comprising controlling atmospheric humidity while coating and heating the sapphire fiber.

6. The method of claim 4 wherein coating comprises coating multiple layers.

7. The method of claim 4 wherein coating comprises at least one of dipping and pulling.

8. A sensor fabrication method comprising:
using chemical vapor deposition to apply magnesium aluminum oxide (MgAl₂O₄) around a sapphire fiber.

9. The method of claim 8 wherein using chemical vapor deposition comprises
depositing the MgAl₂O₄ around the sapphire fiber,
heating the sapphire fiber and the deposited MgAl₂O₄,
repeating the steps of depositing and heating at least once.

10. A sensor comprising
an optical fiber; and
coating material surrounding at least a portion of the optical fiber,
wherein at least one parameter of the coating material is optimal to minimize normal and shear stresses on the sensor,
wherein the at least one parameter is at least one of melting point, coefficient of thermal expansion, electric modulus, and lattice type.

11. The sensor of claim 10 wherein the at least one parameter comprises melting point, coefficient of thermal expansion, electric modulus, and lattice type.

12. The sensor of claim 111 wherein the lattice type comprises a cubic crystal lattice.

13. The sensor of claim 11 wherein the coating material has a coefficient of thermal expansion greater than or equal to a coefficient of expansion of the optical fiber.

14. The sensor of claim 10 wherein the coating material comprises cladding material, and wherein the cladding material comprises a lower index of refraction than the index of refraction of the optical fiber.

15. The sensor of claim 14 wherein the optical fiber comprises sapphire.

16. The sensor of claim 15 wherein the coating material comprises a spinel.

17. The sensor of claim 16 wherein the spinel comprises magnesium aluminum oxide (MgAl₂O₄).

18. The sensor of claim 10 wherein the optical fiber comprises silica.

19. The sensor of claim 10 wherein the optical fiber includes a diffraction grating.

20. A power generation system comprising a sensor comprising an optical fiber comprising sapphire and cladding material surrounding at least a portion of the optical fiber, the cladding material of the sensor comprising a spinel.
